(19) United States
(12) Patent Application Publication
(10) Pub. No.: US 2013/0340166 A1
(43) Pub. Date: Dec. 26, 2013

(54) MOBILE OPERATING TABLE AND STORAGE DEVICE

(71) Applicants: Scott JOLLEY, Ogden, UT (US); Chris JOLLEY, Midvale, UT (US)

(72) Inventors: Scott JOLLEY, Ogden, UT (US); Chris JOLLEY, Midvale, UT (US)

(21) Appl. No.: 14/012,664

(22) Filed: Aug. 28, 2013

Related U.S. Application Data
(62) Division of application No. 12/582,129, filed on Oct. 20, 2009, now abandoned.
(60) Provisional application No. 61/106,754, filed on Oct. 20, 2008.

(51) Int. Cl. A61G 7/02

(52) U.S. Cl. CPC A61G 7/02
USPC 5/604

(57) ABSTRACT

A mobile operating table or surgical cart providing one or more storage areas for medical supplies and waste containers and providing a drainable top surface suitable for performing a surgical or medical procedure. The storage areas are contained within a cavity inside the mobile operating table's base or within storage trays contained within the base. The mobile operating table or surgical cart is able to be easily transported using two or more swivel casters which can be lockable to prevent unwanted movement. The top surface comprises one or more removable panels, which include at least one perforated insert allowing fluid to pass through to a drainage surface below the panels. The collected fluid is then collected into one or more waste fluid containers.

### CROSS-REFERENCE TO RELATED APPLICATIONS

This application claims the benefit of U.S. Provisional Application 61/106,754, filed Oct. 20, 2008, which is incorporated herein in its entirety to the extent not inconsistent herewith.

### BACKGROUND OF THE INVENTION

The present invention relates to a mobile operating table or surgical cart for use in hospitals and other medical institutions.

Surgical carts are commonly used in hospitals including in-room care as well as operating rooms and emergency rooms. Typically, these surgical carts, such as those disclosed in U.S. Pat. No. 4,790,610 and U.S. 2008/0142386, are used as portable storage devices. For example, the carts can include a system of drawers used to store pharmaceuticals and surgical instruments, although more specialized uses are possible such as blood specimen procurement (U.S. Pat. No. 3,966,286), storage of ophthalmic micro surgical instruments (U.S. Pat. No. 6,022,088), or dispensing of medication (U.S. Pat. No. 4,114,965).

Typically, the top surface of the surgical cart is used as another storage area for surgical instruments, pharmaceuticals or discarded materials after treatment of a patient. The top may even be modified to provide a secure and visible storage area (U.S. 2008/0142386). However, surgical carts in current use do not modify the top surface of the cart in order to allow the cart to be used for a medical or surgical procedure.

In current practice it is often not practical to have a medium or large size operating surface where a doctor, nurse or other medical practitioner can perform a procedure close to every bed or station where patients are waiting treatment. Consequently, patients must be moved from their positions to a suitable location where the doctor or nurse can perform the procedure, or the procedure is performed bedside using relatively small surgical trays. These surgical trays typically do not contain all of the instruments or materials used by the medical practitioner and typically do not provide a means for collecting large amounts of fluid that can result from a procedure.

Because space in medical institutions is often limited, it would be useful if a mobile operating surface could be provided to a patient when a procedure needed to be performed. It would also be useful if this mobile surface could also provide a storage device for holding the medical instruments, medications, or disposal containers for a variety of procedures.

### BRIEF SUMMARY OF THE INVENTION

The present invention relates to a mobile operating table or surgical cart for use in hospitals and other medical institutions. The mobile operating table is similar to mobile carts currently used in hospitals but also provides a top surface adapted for conducting a medical or surgical procedure. The mobile operating table provides an easy-to-use, compact and portable device that is easily transported to patient beds or other locations where patients can be treated. In one embodiment, the invention provides a mobile operating table comprising a hollow base forming an internal storage cavity, a means for being transported, and a top surface comprising a surface depression containing a lowered drainage surface, an outer rim surrounding the top of the surface depression, and one or more panels planarly disposed within the outer rim

The mobile operating table is a surgical cart comprising a hollow base forming an internal storage cavity, a means for being transported, and a top surface adapted for surgical use. While it is preferable that the mobile operating table is approximately rectangular, the mobile operating table can be any shape, including but not limited to rectangular, circular, elliptical, triangular, trapezoidal, irregular, and combinations thereof, that allows the mobile operating table to provide a suitable top surface for a medical or surgical procedure and an inner storage space able to contain necessary or useful medical instruments, supplies, medications, or disposal containers. The shape and size of the mobile operating table can be adjusted to a size and shape that is practical for transport into hospital rooms, placement next to patient beds, and storage for when not in use.

The means for being transported refers to any system of rollers, casters, wheels or treads allowing the mobile operating table to be easily moved as is know in the art. In one embodiment, the mobile operating table contains 4-6 wheels or casters attached to the bottom of the base. In one embodiment, the device comprises two or more swivel casters allowing the device to maneuver in small areas of a patient room or an emergency room. The wheels or casters are able to be locked and prevent movement by the mobile operating table in order to stabilize the table when a surgical or medical procedure is being conducted. Preferably the swivel casters are locking casters such as those provided by Tente Casters, Inc. (Hebron, Ky., U.S.A.).

The base of the mobile operating table comprises an inner storage cavity that is accessible on at least one side of the base. In one embodiment, the base comprises one or more access doors providing access to the inner cavity. In a further embodiment, the base comprises two outwardly opening access doors providing access to the inner cavity. The inner cavity provides a suitable storage area for containers, waste containers such as disposal containers for sharp objects, surgical trays, surgical instruments, and medical supplies. In one embodiment, the inner surface of the one or more access doors, i.e., the surface that faces toward the inner cavity when the one or more doors are closed, comprises one or more trays or compartments for additional storage. Preferably, the trays or compartments comprise a transparent top or side allowing the contents of the tray or compartment to be visualized. In a further embodiment, the base comprises one or more drawers disposed within the inner cavity. Optionally, the outer surface of the access doors or the base comprises one or more additional trays or compartments also able to hold containers, surgical instruments or waste products. Additional storage is provided by attaching one or more storage brackets to the side of the mobile operating table. The storage brackets are designed to hold containers, such as disposal containers for needles or other sharp objects, allowing a medical practitioner to easily dispose or store objects without having to open the access doors or a storage tray. The brackets can be mounted anywhere on the mobile operating table to allow for the most ergonomic and efficient disposal and storage while performing repetitive procedures with the mobile operating table.

The one or more access doors may comprise a handle to allow easy opening and closing, and may further comprise a locking mechanism to prevent unauthorized entry into the storage area in the inner cavity. The locking mechanism can be any mechanism known in the art, such as a latch that is locked and unlocked using a key.

The mobile operating table further comprises a surface depression disposed in the top surface of the mobile operating table. The surface depression occupies a large enough area of the top surface so as to allow a medical or surgical procedure to be performed over the surface depression. The bottom of the surface depression forms a lower drainage surface able to collect fluid and materials resulting from the medical or surgical procedure. Optionally, the surface depression contains a drainage plate or screen positioned above the lower drainage surface to allow fluid to pass through to the lower drainage surface while preventing large solids from passing through to the lower drainage surface.

The mobile operating table further comprises an outer rim surrounding the top of the surface depression and one or more panels planarly disposed within the outer rim. Panels able to be planarly disposed within the outer rim include surgical trays and flat or substantially flat inserts, such as solid removable spacer inserts and perforated screen inserts. The solid removable spacer inserts are flat or substantially flat sheets that provide a solid continuous surface, while the perforated screen inserts contain multiple holes or gaps that allow fluids and small solids to pass through the insert. The surgical trays, removable spacer inserts and/or perforated screen inserts are able to securely attach to each other and the inner surface of the outer rim to form a weight bearing operating surface able to hold significant weight without collapsing. The surgical trays and inserts can be removed from the outer rim for cleaning or replaced with other surgical trays or inserts. Preferably, the operating surface of the mobile operating table is sterile or is able to be sterilized. Optionally, the edges of the surgical trays, inserts and the inner edges of the outer rim are modified to provide locking features with other edges, or are modified to be rounded or form flanges to eliminate sharp edges.

The surgical trays, removable spacer inserts and perforated screen inserts are interchangeable and can be removed and replaced with each other. Thus, the top surface can comprise a varying number of surgical trays, removable spacer inserts and perforated screen inserts positioned in different configurations depending on the surgical or medical procedure to be performed. For example, in one embodiment the top surface comprises three removable spacer inserts and a single perforated screen insert, where the perforated screen insert is positioned above a drainage outlet in the lowered drainage surface which is in fluid communication with a fluid waste container. Preferably the surgical or medical procedure is performed on or above the perforated screen insert so that any fluid generated during the procedure is collected in the lowered drainage surface and transported to a fluid waste container. Any necessary instruments or materials are stored on top of the removable spacer inserts within easy reach of the medical practitioner.

Surgical and medical procedures suitable for use with the mobile operating table of the present invention include, but are not limited to, drawing blood or other bodily fluids, administering injections, inserting or removing stitches, applying or changing bandages, examining or washing a wound, administering medication or fluids to a patient, including topical and intravenous administrations, and prepping a patient for more extensive surgery. The top surface provides an unobstructed and sterile surface having adequate space to allow the medical practitioner to perform the surgical or medical procedure and hold any necessary medical instruments, supplies or medication for the procedure. For example, if a doctor is administering stitches to a patient's arm, the mobile operating table would allow the doctor to place the patient's arm on the operating surface and provide space for the doctor to suture the wound. The top surface would also provide an area for the suturing material, bandages, any anesthetics to be administered, and any solutions for washing the wound.

In one embodiment, the lowered drainage surface comprises one or more drainage ports to collect fluid generated during the procedure and funnel the fluids to one or more waste fluid containers. In one embodiment, one side of the base, preferably the side opposite the access to the inner cavity, comprises a rear compartment able to hold one or more waste fluid containers able to receive a fluid from the one or more drainage ports. The rear compartment may be a tray or structure extending from the base of the mobile operating table, or the rear compartment may be a depression in the base forming a shelf. The lowered drainage surface may be angled in order to funnel any collected fluid to the one or more drainage ports.

The mobile operating table of the present invention may further comprise additional attachments useful during a surgical or medical procedure. For example, the mobile operating table may comprise an IV pole or an IV stand.

Preferably, the base, outer rim, surgical trays and panel inserts are made from a material, such as metal or hard plastic, resistant to leaks and chemical degradation. Preferably, the mobile operating table or its components are made from metal, such as stainless steel, a hard plastic, or combinations thereof. At least one section of the mobile operating table is color coded or otherwise labeled indicating the materials stored or to be stored in the base. In one embodiment, the base has a width between approximately 20 inches and 50 inches, a height between approximately 25 inches and approximately 54 inches, and a depth (from front end to rear end) between approximately 18 inches and 30 inches. In a further embodiment, the mobile operating table has a width of approximately 30 inches, a height of approximately 30 inches, and a depth of approximately 20.5 inches. Preferably the base does not extend to the floor when the mobile operating table is in use. It is preferable that there is gap between the floor and the bottom of the base forming an open area for the feet of a medical practitioner performing a medical or surgical procedure or transporting the device. Optionally, the mobile operating table comprises a hydraulic lift system allowing the height of the base to be raised and lowered as desired by the medical practitioner.

The depth of the surface depression (from the lowered drainage surface to the top of the surface depression) can be any depth that is practical for use. Preferably, the surface depression has a depth between approximately 1 inch and approximately 20 inches, more preferably between approximately 1 inch and approximately 12 inches.

The present invention further comprises surgical trays, such as suture trays, able to be planarly disposed within the outer rim, wherein the surgical trays contain a perforated cover over the top of the tray. Needles or other sharp objects are able to be held in place by inserting the objects into the perforated cover. Part or the entire perforated cover is easily removed, allowing materials to be stored within the surgical tray prior to use and allowing discarded materials to be placed into the surgical tray after use. The surgical tray may also comprise an irrigation drain at the bottom of the tray, which optionally comprises a removable drain cover. In one embodiment, the surgical tray further comprises supplies and materials for a surgical or medical procedure. For example, the surgical tray may include, but is not limited to, forceps, scissors, a suturing needle, suturing material, syringes, an anesthetic such as a vile of lidocaine, irrigation and cleaning solutions, a sharps container, gauze, bandages, and sterile drapes. In one embodiment, the surgical tray is inserted within the outer rim of the mobile operating table in the place of a perforated screen insert. Any fluid generated by the surgical or medical procedure is collected in the bottom of the tray and is passed through the irrigation drain to the lowered drainage surface.

In illustrative embodiments, the methods and devices described herein provide a mobile device able to provide storage for medical supplies and waste containers and provide a drainable surface suitable for a surgical or medical procedure.

### BRIEF DESCRIPTION OF THE DRAWINGS

FIG. 1 shows an exemplary mobile operating table of the present invention where the storage space in the base of the mobile operating table is covered by a pair of lockable access doors. The top surface contains several panels positioned within the outer rim with a panel removed to provide access to the surface depression.

FIG. 2 shows an exemplary mobile operating table as depicted in FIG. 1 but with a perforated screen insert positioned as one of the panels within the outer rim.

FIG. 3 shows an exemplary mobile operating table as depicted in FIG. 2 but with the lockable access doors on the front of the base opened to display the inner cavity of the base. A pair of storage trays is present on the inner surface of each access door to provide additional storage compartments.

FIG. 4 shows the rear side of an exemplary mobile operating table as depicted in FIG. 2 where the base contains a rear compartment holding one or more waste fluid containers. The rear compartment is fluidly connected to the lowered drainage surface (not shown) allowing fluids in the lowered drainage surface to drain into the waste fluid containers.

FIG. 5 shows an exemplary mobile operating table as depicted in FIG. 1 but with all of the panel inserts removed from the top surface. The lower drainage surface is shown with a drainage port able to drain fluids to one or more waste fluid containers in the rear compartment as shown in FIG. 4.

FIG. 6 shows an exemplary mobile operating table as depicted in FIG. 5 further comprising an additional drainage plate containing several screened drains to catch any foreign objects. Fluid collecting on the drainage plate passes through the screened drains and to the drainage port in the lower drainage surface.

FIG. 7 shows a sharps disposal container inserted in a storage bracket attached to the base of the mobile operating table. The bracket can be mounted on the base so as to be easily accessible for needle disposal while performing medical procedures.

FIGS. 8A-8C show an exemplary suture tray of the present invention. As shown, the suture tray may contain a removable perforated cover over the top of the tray and an irrigation drain at the bottom of the tray.

Additional features and advantages of the present devices and methods may be obtained by reference to the following detailed description and accompanying drawings that set forth illustrative embodiments, in which the principles of the methods, devices and apparatuses are utilized.

### DETAILED DESCRIPTION OF THE INVENTION

Unless defined otherwise, all technical and scientific terms used herein have the same meaning as commonly understood by one of ordinary skill in the art to which this invention belongs. Generally, the nomenclature used herein are well known and commonly employed in the art. Terms of orientation such as “up” and “down”, “top” and “bottom”, “above” and “underneath”, “front” and “rear”, or “upper” or “lower” and the like refer to orientation of parts during use of a device. Where a term is provided in the singular, the inventors also contemplate the plural of that term. Where there are discrepancies in terms and definitions used in references that are incorporated by reference, the terms used in this application shall have the definitions given herein. As employed throughout the disclosure, the following terms, unless otherwise indicated, shall be understood to have the following meanings.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms.

The term “in fluid communication” or “fluidly connected” as used herein means that a component of the device or apparatus is directly or indirectly connected to a second component so that a fluid is able to pass through one component to the other component.

As used herein, the term “planarly disposed” means one or more objects, such as surgical trays, removable spacer inserts and perforated screen inserts, are positioned to form a flat or substantially flat surface within the plane defined by the outer rim.

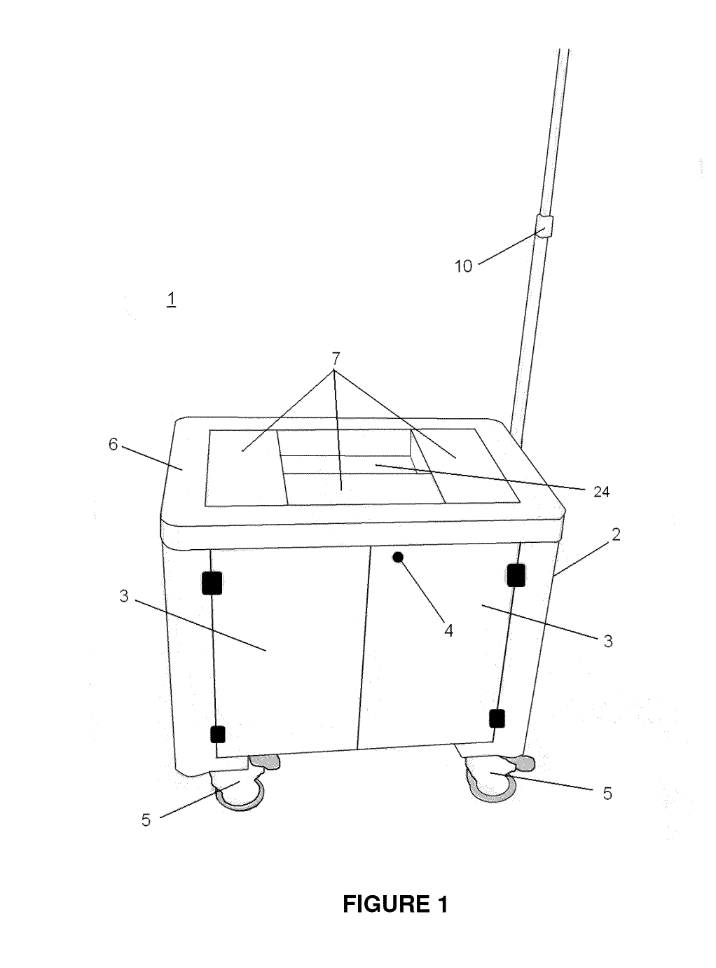

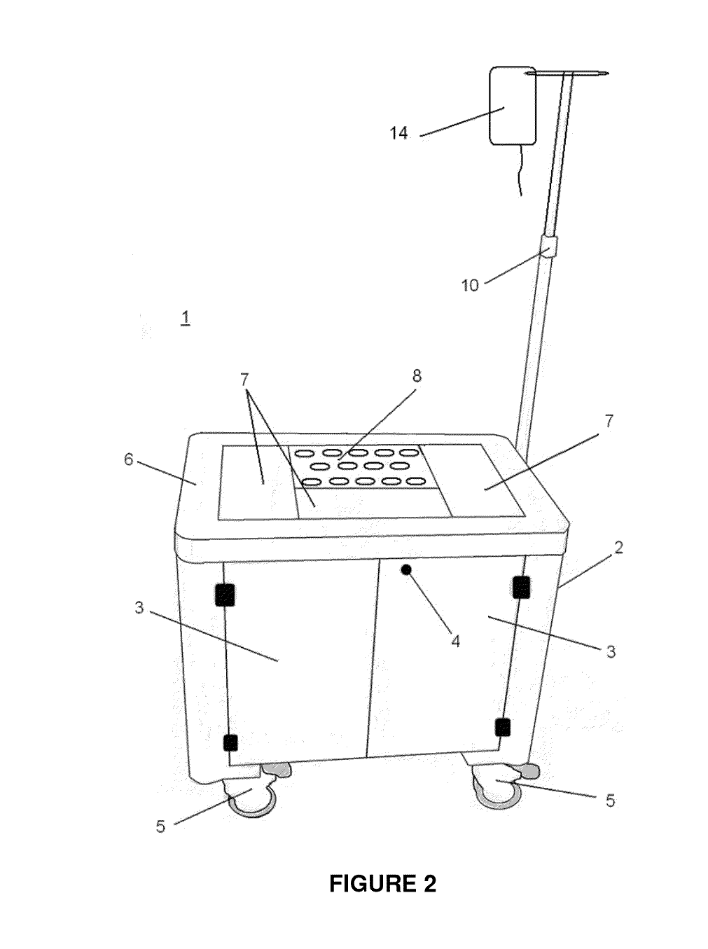

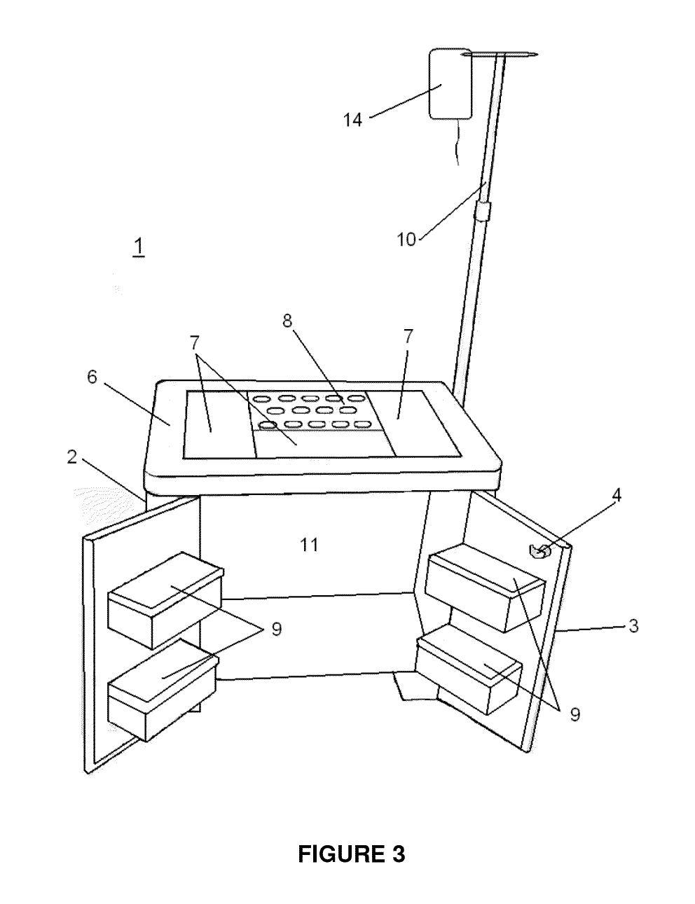

In one aspect, the invention comprises a mobile operating table as shown in FIGS. 1-7. As shown in FIG. 1, the mobile operating table 1 comprises a rectangular base 2 housing an inner cavity 11 (shown in FIG. 3). The inner cavity 11 is covered by a pair of access doors 3, which optionally are held shut by a locking mechanism 4. The base 2 rests on two or more locking casters 5, allowing the mobile operating table 1 to be easily transported. The base 2 may further comprise an IV stand 10 able to hold an IV bag 14 (shown in FIGS. 2 through 4), the contents of which are administered to a patient.

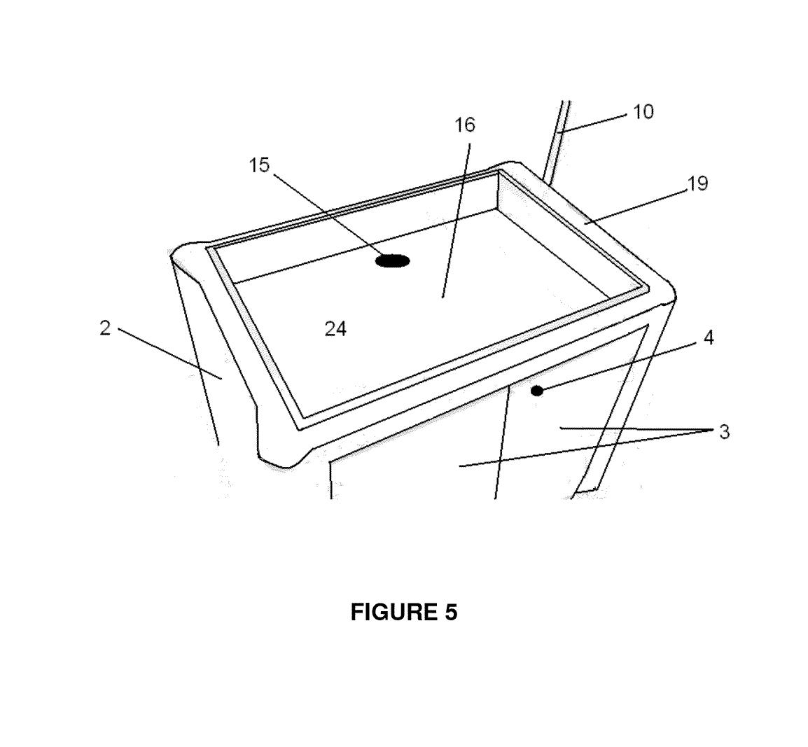

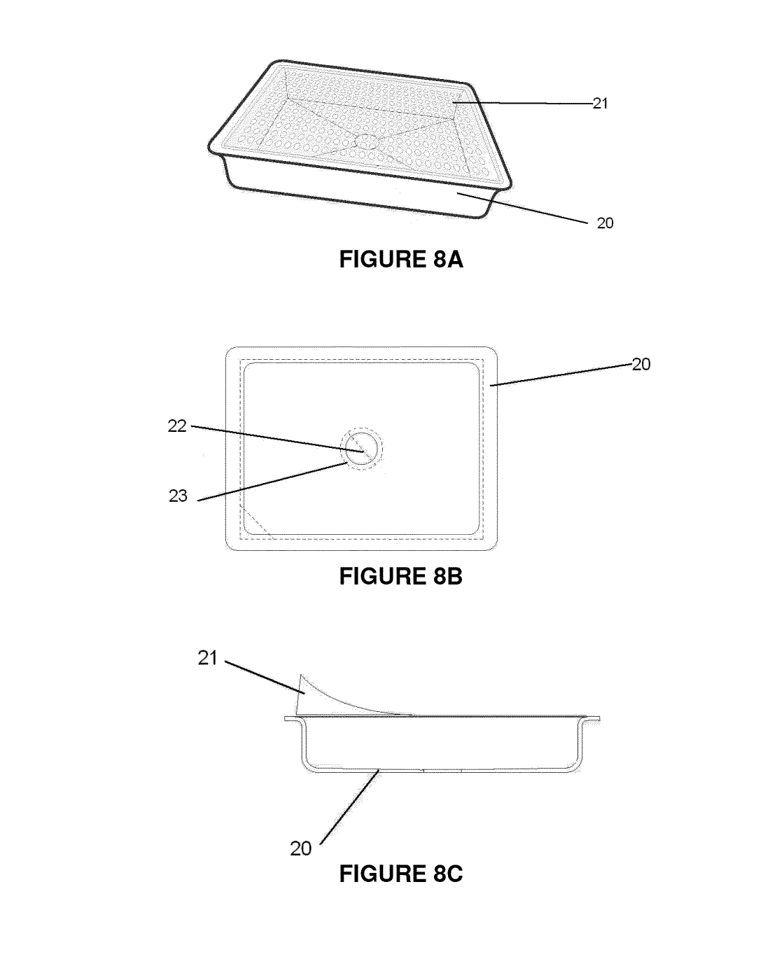

The top surface 19 of the mobile operating table 1 contains a surface depression 24 having a lowered drainage surface 16 (shown in FIG. 5). An outer rim 6 (such as shown in FIGS. 1-4) surrounds the top of the surface depression 24 and contains one or more panels or surgical trays inserted within the outer rim 6 to form a flat or substantially flat surface. The panels can be solid spacer inserts 7 but should contain at least one perforated screen insert 8 (shown in FIGS. 2 through 4) or surgical tray having a drain (such as the suture tray 20 shown in FIG. 8B). The perforated screen insert 8, allows fluid generated during a surgical or medical procedure, such as saline solution, water, blood and other bodily fluids, irrigation fluid, washing fluid and combinations thereof, to drain to the lowered drainage surface 16 below the panel inserts. Preferably, the spacer inserts 7 and perforated screen inserts 8 are made from 304 stainless steel (SST) or ABS molded plastic.

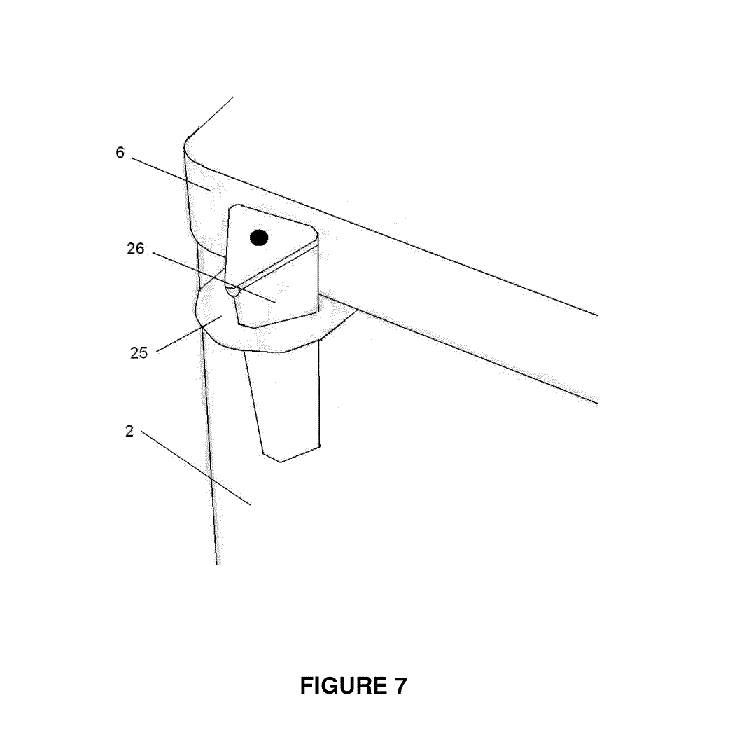

As shown in FIG. 3, the access doors 3 can be opened to provide access to the inner cavity 11 and storage trays 9 which are used as storage compartments for medical supplies, surgical trays or waste containers. Preferably, the inner surfaces of the access doors 3 are fabricated to hold one or more storage trays 9, approximately 4 inches deep, for easy access. As shown in FIG. 7, additional storage can be provided by attaching one or more storage brackets 25 to the base 2 of the mobile operating table. The brackets 25 are designed to hold containers, such as disposal containers 26 for needles or other sharp objects, allowing a medical practitioner to easily dispose or store objects without having to open the access doors 3 or a storage tray 9. For needles and other sharp objects, the objects can be placed in the disposal container 26 during the medical procedure and the disposal container 26 itself removed and disposed of after the procedure is completed.

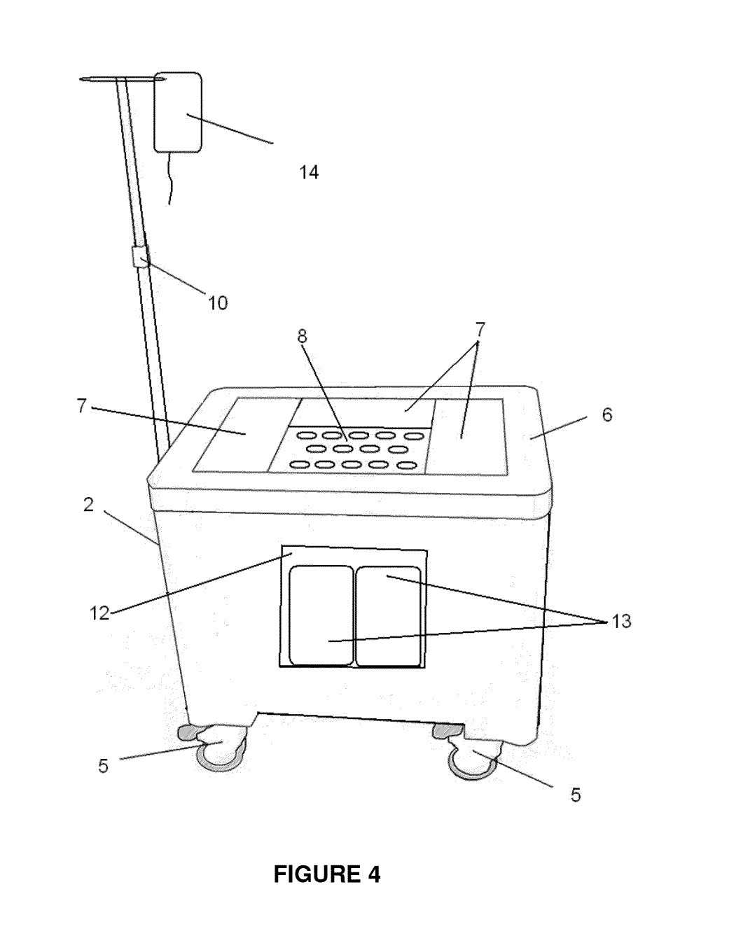

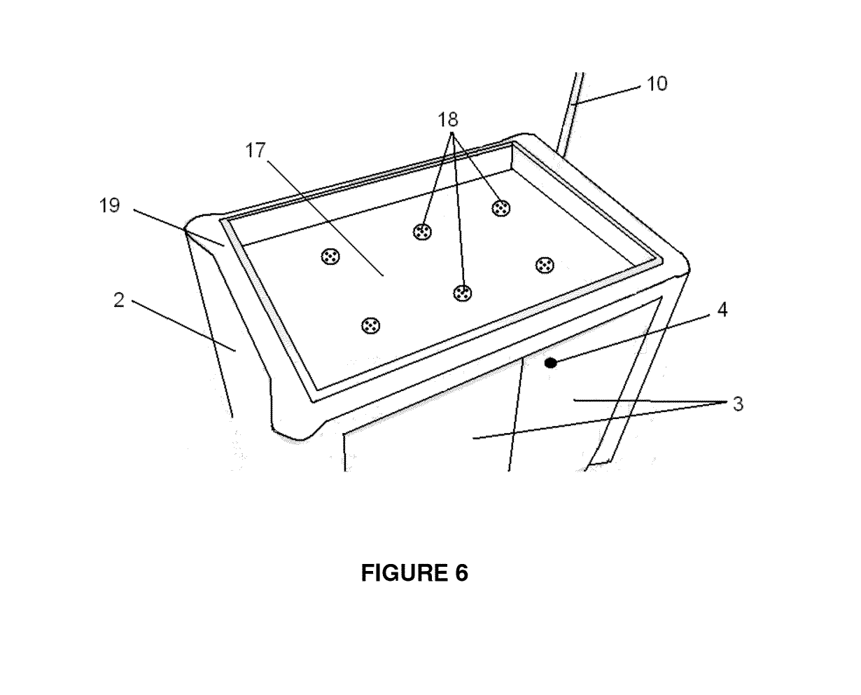

As shown in FIG. 4, the rear of the base 2 may contain a rear compartment 12 able to hold one or more waste fluid containers 13. Alternatively, the waste fluid containers 13 may be placed within the inner cavity 11 of the base 2. The waste fluid containers 13 are fluidly connected to a drainage port 15 disposed in the lower drainage surface 16 (shown in FIG. 5). As shown in FIG. 6, a drainage plate 17 having one or more screened drains 18 may be inserted approximately 1-6 inches over the lower drainage surface 16 to collect any foreign objects within the fluid.

In one aspect of use of the present invention, a medical practitioner will push the mobile operating table next to a patient and lock the casters 5 so the mobile operating table no longer can move. If the patient requires an intravenous fluid, the IV bag 14 containing the fluid can be attached to the IV stand 10 on the base 2. Any necessary or desired medical supplies or containers are stored within the inner cavity 11 inside the base 2. The medical supplies or containers are removed from the base 2 and placed on the operating surface on the top of the mobile operating table 1 formed by one or more spacer inserts 7 and perforated screen inserts 8 inserted within the outer rim 6. The part of the patient's body that requires the surgical or medical procedure is gently placed over the perforated screen insert 8 and the procedure performed. Any fluid generated by the procedure passes through the perforated screen insert 8 and onto the drainage plate 17 covering the lowered drainage surface 16. The drainage plate 17 contains several screened drains 18 allowing the fluid, but not any foreign objects, to pass to the drainage port 15 and to the rear compartment 12, where the fluid is collected in a waste fluid container 13.

The spacer inserts 7 and perforated screen inserts 8 are removable and can be sterilized according to medical standards. When the procedure is completed, the waste products and unused supplies are placed in the storage areas of the mobile operating table and transported to the appropriate disposal or storage sites. In one embodiment, the perforated screen insert 8 are replaced by a surgical tray such as a suture tray 20 as shown in FIGS. 8A through 8C. The suture tray 20 comprises a perforated cover 21 and an irrigation drain 22 at the bottom of the tray. The perforated cover 21 is optionally connected to the suture tray 20 through the use of adhesives and may be completely removed or partially removed. Needles or sharp objects may be inserted through the perforated cover 21 when not in used. The irrigation drain 22 may have a removable drain cover 23 which is removed when the suture tray 20 is ready to be used. The suture tray 20 may contain medical supplies, materials, containers and kits related to a surgical or medical procedure. The kits or materials contained within the surgical tray may be specific to a particular procedure and stored within the inner cavity 11 of the base 2. Furthermore, the base 2 may contain surgical trays specific to different common procedures allowing the medical practitioner can select which surgical tray is most appropriate for the procedure.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description.

All references cited in this application are hereby incorporated in their entireties by reference to the extent that they are not inconsistent with the disclosure in this application. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques specifically described herein are intended to be encompassed by this invention.

1-17. (canceled)

18. A method of treating a patient comprising the steps:
(a) providing a mobile operating table comprising a hollow base forming an internal storage cavity, a means for being transported, and a top surface comprising a surface depression containing a lowered drainage surface, an outer rim surrounding the top of the surface depression, one or more panels planarly disposed within the outer rim, one or more drainage ports disposed in the lowered drainage surface, and one or more waste fluid containers in fluid communication with said one or more drainage ports;
(b) transporting said mobile operating table to a patient;
(c) placing a body part of the patient on or above the one or more panels wherein a surgical or medical procedure is performed on said body part.

19. The method of claim 18 further comprising collecting a fluid generated by said surgical or medical procedure in the lowered drainage surface and draining said collected fluid to said one or more waste fluid containers.

20. The method of claim 19 further comprising transporting surgical or medical supplies within the internal storage cavity to said patient.

21. The method of claim 18 further comprising attaching said one or more panels to each other and the inner surface of the outer rim to form a weight bearing operating surface.

22. The method of claim 18 wherein said surgical and medical procedures are selected from the group consisting of: drawing blood or other bodily fluids, administering injections, inserting or removing stitches, applying or changing bandages, washing a wound, administering medication or fluids to a patient, and prepping a patient for more extensive surgery.

23. The method of claim 18 wherein the mobile operating table further comprises a drainage plate having one or more screened drains disposed within the surface depression above the lowered drainage surface.

24. The method of claim 18 wherein the mobile operating table further comprises one or more storage trays or storage compartments within said inner storage cavity.

25. The method of claim 24 wherein the mobile operating table further comprises one or more lockable access doors providing access to said inner storage cavity.

26. The method of claim 25 wherein said one or more storage trays are disposed on the inner surface of the one or more lockable access doors.

27. The method of claim 18 wherein the means for being transported comprises two or more swivel casters.

28. The method of claim 27 further comprising the step of locking the casters so the mobile operating table no longer can move.

29. The method of claim 18 wherein said one or more panels comprise a perforated screen.

30. The method of claim 18 wherein said one or more panels comprise a surgical tray.

31. The method of claim 18 wherein said one or more panels are sterilized.

32. The method of claim 18 wherein the mobile operating table further comprises a storage bracket attached to the base of the mobile operating table, and a sharps disposal container inserted in the storage bracket.

33. The method of claim 32 further comprising the step of disposing needles or other sharp objects into said sharps disposal container during the surgical or medical procedure.
